(19) United States
(12) Patent Application Publication
(10) Pub. No.: US 2024/0011582 A1
(43) Pub. Date: Jan. 11, 2024

(54) DRAINAGE SYSTEM FOR POST BURIAL DETECTION

(71) Applicant: Keith Allen Wilcox, Lake Odessa, MI (US)

(72) Inventor: Keith Allen Wilcox, Lake Odessa, MI (US)

(21) Appl. No.: 18/124,432

(22) Filed: Mar. 21, 2023

Related U.S. Application Data
(63) Continuation-in-part of application No. 17/810,913, filed on Jul. 6, 2022, now abandoned.

(51) Int. Cl. F16L 1/11; F16L 11/04

(52) U.S. Cl. CPC F16L 1/11; F16L 11/04; F16L 2201/60

(57) ABSTRACT

A drainage system and method for post burial detection thereof according to the present invention comprises a corrugated drain tile with a tracer wire to facilitate detection of the drainage tile when buried. The drain tile defines a drain tile body, a first end, a second end, a longitudinal length extending from the first end to the second end, an inner surface and an outer surface. The tracer wire is preferably affixed to the drain tile during or post manufacture of the drain tile and is composed of a conductive material such as copper, steel, or stainless steel. The tracer wire extends along the longitudinal length of the drain tile, along the outer surface, or the inner surface, and is at no point embedded within the drain tile body.

### CROSS REFERENCE TO RELATED APPLICATIONS

This application is a continuation-in-part of U.S. Utility patent application Ser. No. 17/810,913 filed on Jul. 6, 2022, which is hereby incorporated by reference in its entirety for all purposes.

### TECHNICAL FIELD

The present disclosure relates generally to the field of drainage systems for post-burial detection. Specifically, the present disclosure relates to a drainage tile with a tracer wire to facilitate the ability to locate the drainage tile when buried.

### BACKGROUND

Various utilities pipes, such as electric pipes, gas pipes, water supply pipes, and sewage pipes are buried to keep them unobtrusive and out of the way. However, this makes it difficult to locate the utility pipes and creates a hazard when digging in areas where the utilities may have been buried.

Several detection methods exist to locate buried pipes and utilities. For instance, pipes that are composed of a conductive material, or that contain conductive components, may be detected by magnetometer devices or by applying radio frequency (RF) signals to the pipe and utilizing a specialized sensing device to detect the buried pipe. The most prevalent location method is electromagnetic location where a piece of specialized equipment introduces a signal, such as an electric current, to the buried line and then a receiver detects the electromagnetic field created around the utility line. However, none of these methods work with nonconductive utility pipes. Therefore, many utility lines are composed of a conductive material or contain a conductive cable or wire. For instance, buried electrical wires, phone wires, and other communication wires are inherently conductive and can, by themselves, be detected by the aforementioned methods. Similarly, some potable water supply pipes are composed of ductile iron, which is conductive and detectable. Other utilities, such as fiber optic lines, and gas lines, contain a conductive wire that facilitates detection of the buried pipes.

However, none of these methods work on plastic, and there is no conventional location technique for detecting buried plastic or PVC. Therefore, utility companies for water supply and sewer pipes often rely on detailed surveys, land notes, and curb markings to identify the location of buried plastic pipes. These methods are not always exact and often lead to the necessity of digging numerous holes to pinpoint the location of those pipes.

Moreover, not all buried pipes are charted. While utility companies typically keep records of the locations of their pipes, the same is not always true for non-utility water pipes such as drain tile. As used in this disclosure, the term “drain tile” refers to water pipes used to passively facilitate the evacuation of water from one area to another. These pipes have historically been constructed from polyvinyl chloride (PVC) or other plastics, or from other materials such as clay. Plastic is predominantly used today for a myriad of reasons, including the broad range of plastic types and the availability of different flexibilities and malleability, and the fact that plastic is impervious to rust and corrosion.

In accordance with the prior art, drain tile can embody numerous different forms and associated functions. Solid/non slotted drain pipe, which can be constructed from PVC pipe or corrugated plastic piping, is used for relocating collected water from a single-entry point. Often, solid drain tile is associated with drain spouts, irrigation ditches, or other water flow points. Alternatively, drain tile can be porous, or it can be perforated/slotted with small holes to allow passive flow of water from surrounding soil and sediment. These drain tiles create a channel for water to flow, and the perforations are small enough to allow water to enter the pipe while keeping gravel, soil, and other sediment out. In other words, the drain tiles create a ‘highway’ for water to travel and exit the tile at a designated location. Perforated drain tile is often used for water mitigation in basements, around houses, and in yards, farms, and fields, and function to reduce the amount of ground water in an area, thereby reducing the risk of standing water and/or flooding. In some instances, perforated drain tile is encased in a “sock,” composed of a geotextile, permeable fabric such as polyester, and which is applied to the outside of perforated drain tile like pulling on a sock. These socks function to filter out any sand, silt, or other sediment which may get through the permeations in the drain tile and which may clog pipes and lead to drain system failure.

Drain tile is often used by farmers and other agricultural workers, and is also used when building or renovating buildings, in landscaping, roadwork, and in any number of other situations by professionals and non-professionals to reduce the risk of water collecting in undesirable areas. Thus, the location where the drain tile is buried is often not charted or recorded, which, in combination with the plastic composition of the drain tile, make the tile particularly difficult to locate. For these types of pipes, the only method for discerning the location of the buried pipes is to dig multiple holes in an area until the pipe is found. This is known as the “dig and locate” method.

In some instances, drain tile incorporates global positioning system (GPS) trackers to facilitate post burial location. However, GPS location requires specialized equipment, and is expensive. Moreover, GPS location does not easily provide the depth of the buried water pipes. In such instances, depth can only be determined if an installer recorded the depth at which the pipe was buried and if no further dirt or debris has been subsequently placed over the pipe. Tracer wire is known in the art. A tracer wire is a conductive wire which carries an electrical current, which, with the use of receiving equipment, enables a user to pinpoint the location of the wire. These wires are sometimes laid alongside, spiraled around, or taped to buried pipes. This allows the user to pinpoint the location of the pipe paired to the tracer wire with more accuracy than reliance on surveys and records. Tracer wire also allows a user to locate buried pipe quicker and less intrusively than the dig and locate method.

However, tracer wire that is laid alongside, wrapped around, or taped to buried pipes can become dislodged during transit or installation, resulting in imprecise or inaccurate results when trying to locate the utility pipe. Alternatively, plant roots or animals may move or damage the tracer wire subsequent to burial.

In some instances, tracer wire is integrated into the buried pipes, limiting the risk of the wire becoming separated from the pipe or of being damaged. However, pipes that integrate tracer wires are all non-porous, non-corrugated pipes such as those used for gas pipes, electric pipes, and pressurized water supply pipes. Thus, the problem remains that drainage systems, such as drain tile, are not easily discoverable once buried. This is an especially prevalent problem due to the large amount of drain tile which is laid without recording the location of the drain tile and without undertaking the additional expense, time, and work to concurrently lay tracer wire with the drain tile.

Currently, there are thousands of feet of plastic drain tile installed daily around the world, with no effective way of locating it after installation for maintenance, repairs, or to avoid hitting it when doing nearby excavation. Accordingly, there is an unmet need for a drainage system with integrated tracer wire that resolves the foregoing problems in the prior art.

### SUMMARY

The present disclosure provides for an improved drainage system for post burial detection. The drainage system preferably comprises a drain tile integrated with a tracer wire. The drain tile further preferably defines a drain tile body having a body wall, a body wall thickness, a first end, a second end, a longitudinal length, an inner/interior surface, an outer/exterior surface, an inner diameter, and an outer diameter. The inner diameter further defines a void or channel that extends along the longitudinal length, such as in embodiments wherein the drain tile is tube shaped. In preferred embodiments, the tracer wire runs along the longitudinal length of the drain tile, between the first end and the second end, and facilitates the detection of the drain tile when buried.

In one embodiment, the tracer wire is affixed to the outer surface of the drain tile. In such embodiments, the tracer wire may be covered by a protective layer or coating. However, in other embodiments, the tracer wire is not covered by a protective layer or coating and is simply affixed to the outer surface of the drain tile. In other embodiments, the tracer wire is affixed to the inner surface of the drain tile and travels down a void or channel created by the inner diameter of the drain tile body. In yet another embodiment the tracer wire is encased within the body of the tracer tile, between the inner surface and the outer surface.

Thousands of feet of drain tile are laid around the world every day, a large percentage by private individuals such as farmers or home owners. As such, most buried drain tile is not charted, and its location is not recorded. Nor is there an easy way to locate the drain tile after it is buried. While other types of buried pipe have metal components or encase conductive materials that can be detected by magnetometers or other technologies, drain tile is not manufactured or sold with an integrated tracer wire or other element for detection. Moreover, while some installers may lay a tracer wire next to a drain tile, a separate tracer wire increases the risk that the wire will be damaged or separated from the tile during or post installation. Furthermore, because so much drain tile is laid by private individuals, and not by professionals, much of it is buried without a tracer wire at all. This means that it is incredibly difficult to locate most of the drain tile currently buried. When a farmer notices pooling water in his/her field, it is almost impossible to locate the leaking drain tile without digging up most of the field. When a new home buyer wants to put in a patio in his/her backyard, that homeowner may contact the utility companies to find buried gas, electric, sewer, or telephone lines, but will have no way of knowing if there are any buried drain tile. Affixing the tracer wire directly to the drain tile makes it easier and more likely that an installer will lay detectable drain tile, increasing the ability to locate it at later date.

A preferred embodiment of the present invention comprises:
a corrugated drain tile, the drain tile comprising:
   a drain tile body, wherein the drain tile body defines a body wall, a body wall thickness, a first end, a second end, and a longitudinal length extending between the first and second ends; and
a tracer wire;
wherein the tracer wire is affixed to the drain tile body, but is at no point embedded within the body, and runs along the longitudinal length of the drain tile; and
wherein the tracer wire is configured to indicate a buried location of the drain tile body.

### BRIEF DESCRIPTION OF THE DRAWINGS

The invention will be more fully understood by referring to the following Detailed Description of Specific Embodiments in conjunction with the Drawings, of which:

FIG. 1 is a perspective view of a drainage system in accordance with an embodiment of the current disclosure wherein a tracer wire is affixed to an outer surface of a drain tile.

FIG. 2 is a cross section of the drainage system in FIG. 1, in accordance with an embodiment of the current disclosure, wherein the tracer wire is affixed to the outer surface of the drain tile.

FIG. 3 is a perspective view of the drainage system of FIG. 1, in accordance with an embodiment of the current disclosure, wherein the drain tile and tracer wire are encased in a filter sock.

FIG. 4 is a perspective view of the drainage system in accordance with an embodiment of the current disclosure wherein the tracer wire is affixed to an inner surface of the drain tile.

FIG. 5 is a cross section of the drainage system in FIG. 4, in accordance with an embodiment of the current disclosure, wherein the tracer wire is affixed to the inner surface of a drain tile.

FIG. 6 is a perspective view of the drainage system in FIG. 4, in accordance with an embodiment of the current disclosure, wherein the drain tile and tracer wire are encased in a filter sock.

FIG. 7 is a perspective view of a drainage system in accordance with an embodiment of the current disclosure wherein the tracer wire is embedded within a body of the drain tile, running down a longitudinal length between the outer surface and the inner surface of the drain tile.

FIG. 8 is a cross section of the drainage system in FIG. 7, in accordance with an embodiment of the current disclosure, wherein the tracer wire is embedded within the body of the drain tile, running down the longitudinal length between the outer surface and the inner surface of the drain tile.

FIG. 9 is a perspective view of the drainage system of FIG. 7, in accordance with an embodiment of the current disclosure, wherein the drain tile is encased in a filter sock.

FIG. 10 is a perspective view of the drainage system in accordance with an embodiment of the current disclosure wherein the drain tile is a corrugated pipe, and wherein the tracer wire is affixed to the outer surface of the drain tile.

FIG. 11 is a perspective view of the drainage system of FIG. 10, in accordance with an embodiment of the current disclosure, wherein the drain tile and tracer wire are encased in a filter sock.

FIG. 12 is a longitudinal cross section of the drainage system in accordance with an embodiment of the current disclosure, wherein the drain tile is a corrugated pipe and the tracer wire is affixed to the inner surface of the drain tile.

FIG. 13 is a perspective view of a method in accordance with the current disclosure in which a signal is sent down a tracer wire affixed to a drain tile, and wherein the signal is received by a transceiver to pinpoint the depth and location of a buried drainage system.

FIG. 14 is a flowchart schematically illustrating steps of the method that may be performed by a user utilizing the transceiver to pinpoint the depth and location of a buried drainage system in accordance with the current disclosure.

### DETAILED DESCRIPTION OF SPECIFIC EMBODIMENTS

Embodiments of the present invention relate generally to drainage systems for detection post burial. The present disclosure describes, in detail, specific embodiments with the understanding that the present invention may be susceptible to embodiments in different forms, and that the present disclosure is considered an exemplification of the principles of the invention and is not intended to limit the invention to that described herein.

Notwithstanding the use of different reference numerals in the embodiments, the component parts of the drainage system described in the current disclosure may be the same or similar. The drainage system 10, 20, 30, 40, 50 for post burial detection preferably comprises a drain tile 11, 21, 31, 41, 51 integrated with a tracer wire 12, 22, 32, 42, 52. The drain tile 11, 21, 31, 41, 51 further comprises a drain tile body 13, 23, 33 having a body wall, a body wall thickness 14, 24, 34, an inner/interior surface 15, 25, 35, 55, an outer/exterior surface 16, 26, 36, 46, an inner diameter, an outer diameter, a first end 17, 27, 37, 47, 57, a second end 18, 28, 38, 48, 58, and a longitudinal length 19, 29, 39, 49, 59 encompassing a drain tile 11, 21, 31, 41, 51 length between the first end 17, 27, 37, 47, 57 and the second end 18, 28, 38, 48, 58. Likewise, the tracer wire 12, 22, 32, 42, 52 has a tracer wire length, which runs along the longitudinal length 19, 29, 39, 49, 59 of the drain tile 11, 21, 31, 41, 51. In preferred embodiments, the tracer wire 12, 22, 32, 42, 52 is affixed to the drain tile 11, 21, 31, 41, 51 and runs down the longitudinal length 19, 29, 39, 49, 59, between the first end 17, 27, 37, 47, 57, and the second end 18, 28, 38, 48, 58. In some embodiments, the tracer wire 12, 22, 32, 42, 52 length extends beyond the first end 17, 27, 37, 47, 57 and second end 18, 28, 38, 48, 58 of the drain tile 11, 21, 31, 41, 51 to enable the tracer wire 12, 22, 32, 42, 52 from different sections of drain tile 11, 21, 31, 41, 51 to be connected, to allow the tracer wire 12, 22, 32, 42, 52 to be grounded, and/or to facilitate interaction between the tracer wire 12, 22, 32, 42, 52 and a detecting device. In preferred embodiments, the drain tile 11, 21, 31, 41, 51 is tube shaped, and the inner diameter further defines a void/channel that extends along the longitudinal length 19, 29, 39, 49, 59. This void/channel facilitates the flow of water through the drain tile 11, 21, 31, 41, 51. In some embodiments, the drain tile 11, 21, 31, 41, 51 is encased in a filter “sock” 66, 76, 86, 96. In other embodiments, both the drain tile 11, 21, 31, 41, 51 and tracer wire 12, 22, 32, 42, 52 are encased in the filter “sock” 66, 76, 86, 96.

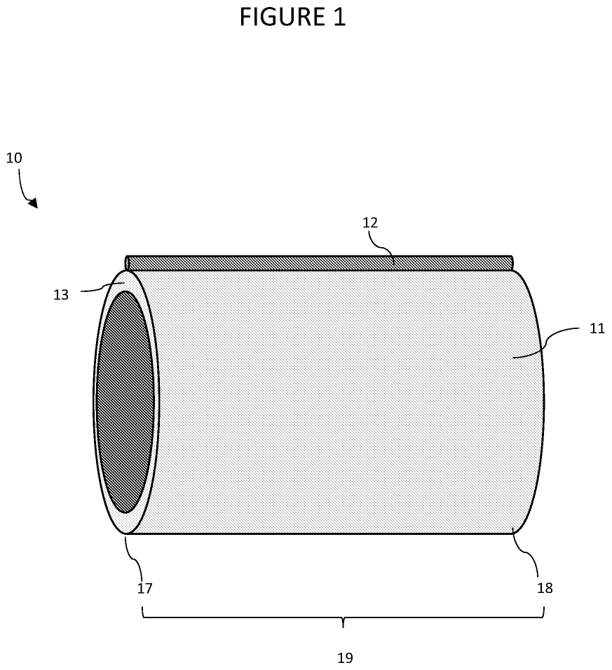

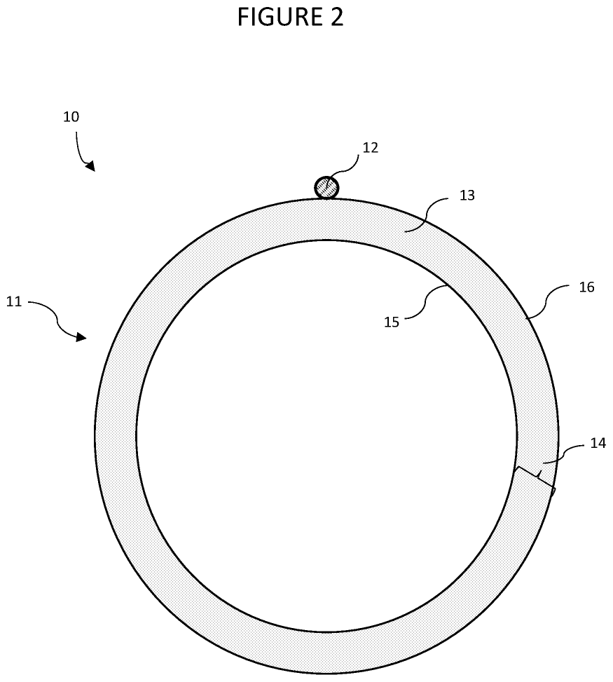

FIG. 1 is a perspective view of an embodiment of the drainage system 10 in which the tracer wire 12 is affixed to the drain tile 11 along the outer/exterior surface 16 of the drain tile 11. FIG. 2 is a cross sectional view further illustrating this embodiment. In some embodiments, the tracer wire 12 is preferably affixed to the outer/exterior surface 16 of the drain tile 11 but is detached from the drain tile body 13, meaning that the tracer wire 12 is affixed to the outer/exterior surface 16, and runs in contact with the outer/exterior surface 16, but is at no point embedded, encapsulated, or otherwise housed within any portion of the drain tile body 13. Generally, in embodiments where the tracer wire 12 is affixed to the outer/exterior surface 16 of the drain tile 11, the length of the tracer wire 12 may run in a straight line in conjunction with the longitudinal length 19 of the drain tile 11, or it may helically wrap the drain tile body 13 between the first end 17 and the second end 18. Location of the drainage system 10 can be ascertained by sending a signal down the tracer wire 12. Because the tracer wire 12 is preferably affixed to the drain tile body 13 and preferably runs in parallel with the drain tile body 13, the location of the tracer wire 12 will enable a user to determine the location of the drainage system 10 using a specialized piece of receiving equipment.

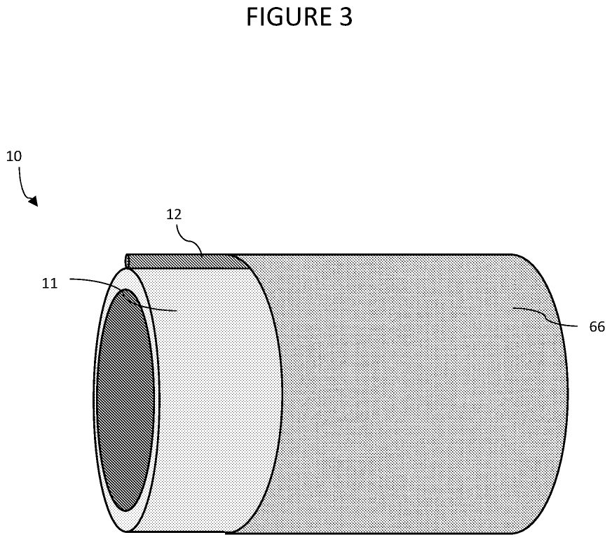

FIG. 3 is a perspective view of a preferred embodiment where the drain tile 11 and tracer wire 12 are encased within the filter sock 66. The drain tile 11 may define a solid or perforated tile. In perforated tile, the filter sock 66 helps to reduce the debris which enters the drain tile 11. In some embodiments, the filter sock 66 serves as the method by which the tracer wire 12 is affixed to the outer/exterior surface 16 of the drain tile 11. In such embodiments, the filter sock 66 may frictionally hold the tracer wire 12 in place against the outer/exterior surface 16, or the filter sock 66 may be used in conjunction with adhesives or other methods that fix the tracer wire 12 to the outer/exterior surface 16.

In other embodiments, the tracer wire 12, is affixed to the drain tile 11 by way of a tube which runs along the outer/exterior surface 16 of the drain tile 11. In other embodiments, the tracer wire 12 is affixed to the outer/exterior surface 16 by a plurality of loops affixed at various intervals along the longitudinal length 19 of the drain tile 11. These embodiments allow the tracer wire 12 to be loosely affixed to the drain tile such that the tracer wire 12 can be pulled through the tube or loops to extend beyond the first end 17 or second end 18 of the drain tile. This facilitates the ability to splice tracer wire 12 from different sections of drain tile 11 together, or to remove and replace the tracer wire 12, should it become damaged. However, other fixation methods are anticipated by this disclosure, and in some embodiments, the tracer wire 12 may be affixed by way of epoxy, adhesives, thermal bonding, or other fastening methods.

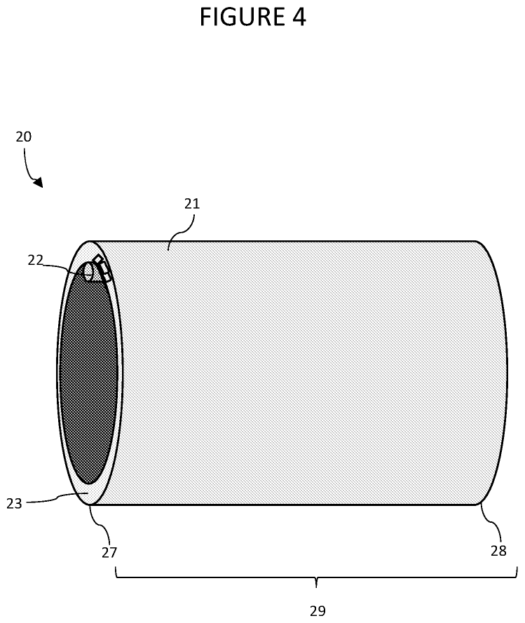

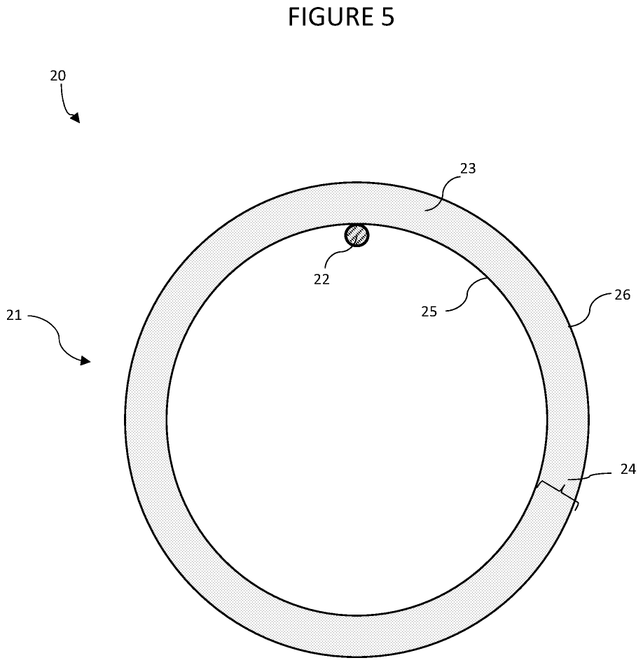

FIGS. 4, 5, and 6 illustrate other embodiments of the drainage system 20, where the tracer wire 22 is affixed to the inner/interior surface 25 of the drain tile 21. In these embodiments, the tracer wire 22 runs the longitudinal length 29 inside the void/channel formed by the inner diameter of the drain tile 21. In such embodiments, the drain tile body 23 provides some protection to the tracer wire 22 from damage from dirt, sediment, animals, or other elements once the drainage system 20 is buried. The location of the tracer wire 22 in juxtaposition to the drain tile 21 facilitates identification of the position of the drainage system 20 with the use of a transceiver. In some embodiments, the tracer wire 22 is affixed to the inner/interior surface 25 of the drain tile 21 but is detached such that at no point is any portion of the tracer wire 22 embedded, encapsulated, or otherwise housed within any portion of the drain tile body 23.

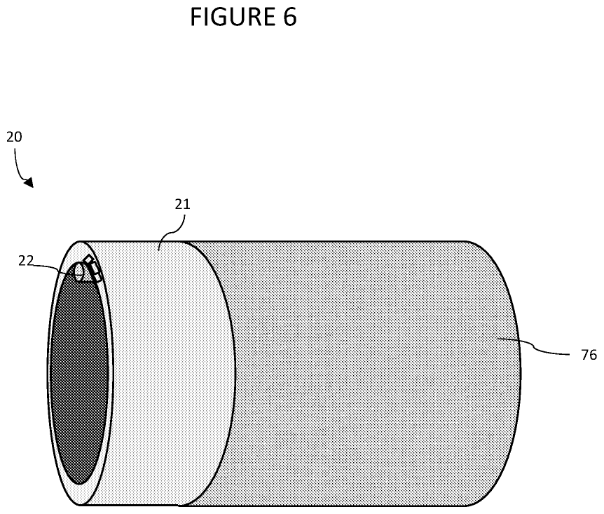

FIG. 6 is a perspective view of a preferred embodiment where the drain tile 21 is encased within the filter sock 76. The filter sock 76 may encase drain tile 21 that is solid or perforated. In perforated tile, the filter sock 76 helps to reduce the debris which enters the drain tile 21.

In some embodiments, the tracer wire 22 is affixed to the drain tile 21 by way of a tube which runs along the inner/interior surface 25 of the drain tile 21. In other embodiments, the tracer wire 22 is affixed to the inner/interior surface 25 of the drain tile 21 by a plurality of loops affixed at various intervals along the longitudinal length 29 of the drain tile 21. These embodiments allow the tracer wire 22 to be loosely affixed to the drain tile 21 such that the tracer wire 22 can be pulled through the tube or loops to extend beyond the first end 27 or second end 28 of the drain tile. This facilitates the ability to splice tracer wire 22 from different sections of drain tile 21 together, or to remove and replace the tracer wire 22, should it become damaged. However, other fixation methods are anticipated by this disclosure, and in some embodiments, the tracer wire 22 may be affixed by way of epoxy, adhesives, thermal bonding, or other fastening methods.

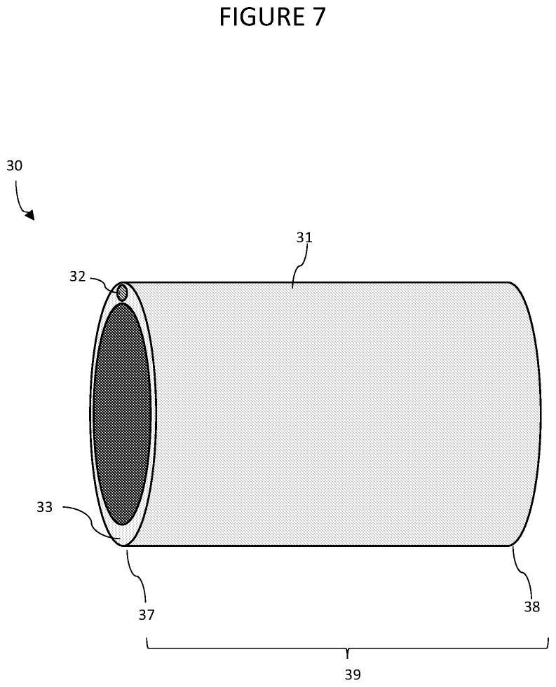

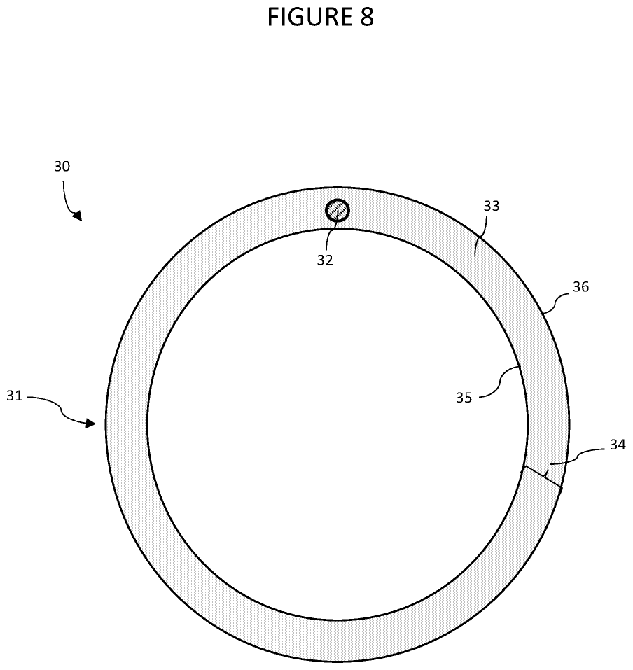

In yet another embodiment of the drainage system 30 illustrated by FIGS. 7, 8, and 9 the tracer wire 32 is embedded within the drain tile body 33, running down the longitudinal length 39 between the inner/interior surface 35 and the outer/exterior surface 36. In these embodiments, the tracer wire 32 is enclosed within the body wall thickness 34. In some embodiments, the tracer wire 32 is embedded directly into the plastic of the drain tile body 33 during manufacturing. In other embodiments, the drain tile body 33 is created with a hollow channel running the longitudinal length 39 of the drain tile 31, through which the tracer wire 32 is threaded. In such embodiments, the tracer wire 32 may be loosely embedded within the body wall thickness 34 of the drain tile 31 so that the tracer wire 32 can be pulled through the drain tile 31 to extend beyond the first end 37 and/or second end 38. These embodiments also facilitate the replacement of the tracer wire 32 should it become damaged. However, other methods of embedding the tracer wire 32 in the drain tile body 33 are envisioned by the current disclosure.

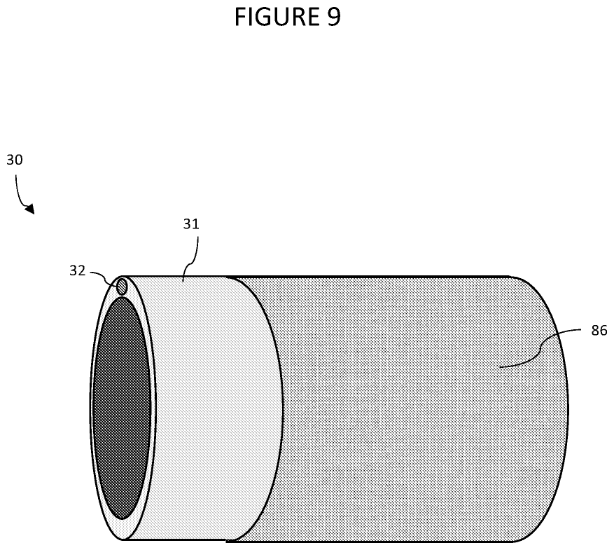

In some embodiments, illustrated in FIG. 9, the drain tile 31 is encased within the filter sock 86. The filter sock 86 may encase drain tile 31 that is solid or perforated. In perforated tile, the filter sock 86 helps to reduce the debris which enters the drain tile 31.

Embodiments where the tracer wire 32 is embedded within the drain tile body 33 provide the most security and protection for the tracer wire 32. Moreover, in such embodiments, the tracer wire 32 is closely associated with the drain tile 31, facilitating the ability to acquire a more precise and accurate location of the drain tile 31 by way of the tracer wire 32.

In still other embodiments, the tracer wire 12, 22, 32 can be embedded in the body wall thickness 14, 24, 34 in a portion of the drain tile 11, 21, 31 and be affixed to the inner/interior surface 15, 25, 35 and/or outer/exterior surface 16, 26, 36 in other portions.

In some embodiments the drain tile 11, 21, 31 is comprised of polyvinyl chloride plastic (PVC). The drain tile 11, 21, 31 may further define a solid PVC pipe, without any perforations, or in other embodiments, the drain tile 11, 21, 31 may define a porous PVC pipe with perforations to allow water diffusion in and/or out of the drain tile 11, 21, 31.

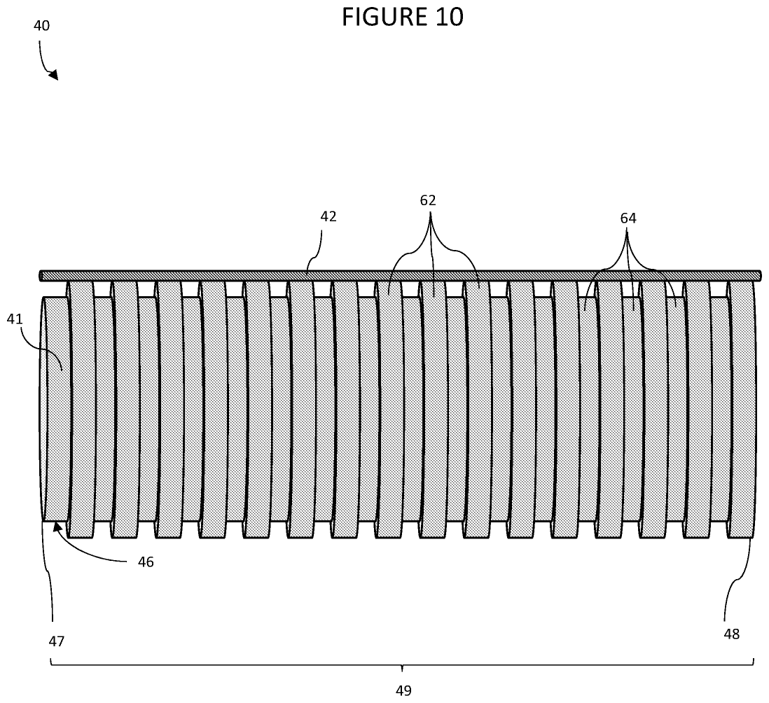

In other embodiments of the drain system 40, 50, the drain tile 41, 51 defines a corrugated tile or pipe. See FIGS. 10, 11, 12. Corrugated tile is shaped with alternating ridges 62, 72 and grooves 64, 74 defining a plastic pipe that is more malleable and flexible than solid PVC pipe, allowing the corrugated tile 41, 51 to bend to accommodate turns and unlevel ground without the use of additional elbow joints and glue required for solid PVC pipes. This means that corrugated tile 41, 51 can run uninterrupted over longer distances than solid PVC pipes, and that installation of the pipe is not restricted to rigid 45- or 90-degree angles. In some embodiments, the drain tile 41, 51 defines a perforated corrugated tile, which allows water to enter the pipe along the longitudinal length 49, 59 while deterring larger debris from entering the pipe.

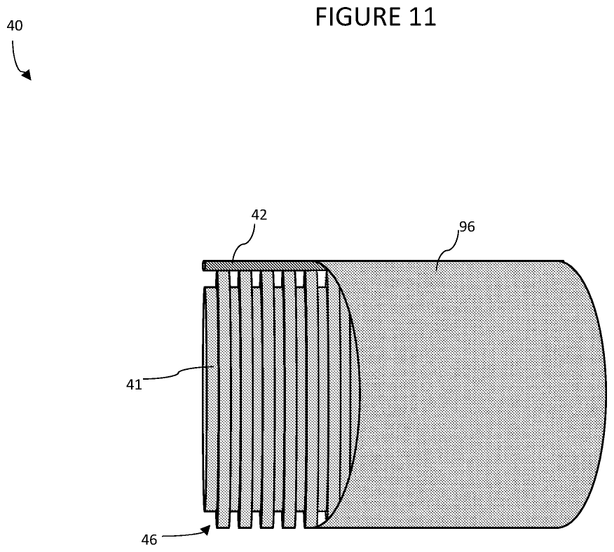

FIGS. 10 and 11 illustrate embodiments of the drain system 40 where the tracer wire 42 is affixed to the outer/exterior surface 46 of the corrugated drain tile 41. In the embodiment illustrated in FIG. 10, the tracer wire 42 is adhered only to the ridges 62 of the corrugated drain tile 41, such that the length of the tracer wire 42 traverses from ridge 62 to ridge 62, and spans over the grooves 64. However, other configurations are anticipated by this disclosure. In one embodiment, the tracer wire 42 is bent and runs in juxtaposition with the ridges 62 and grooves 64 so as to be in continuous contact with the exterior/outer surface 46 of the drain tile 41. In preferred embodiments, the tracer wire 42 is affixed to the exterior/outer surface 46 the drain tile 41 such that the tracer wire 42 is detached from the tile 41 so that the tracer wire 42 is at no point embedded, encapsulated, or otherwise housed within any portion of the drain tile 41. However, it is anticipated that in other embodiments, portions of the tracer wire 42 may be embedded, such as in an embodiment where the tracer wire 42 bisects the ridges 62 so as to be partially encapsulated within the ridges 62 and is affixed to the outer/exterior surface 46 of the drain tile 41 when running through the grooves 64.

In some embodiments, as illustrated in FIG. 11, the drain tile 41 and tracer wire 42 are encased in a filter sock 96. In preferred embodiments, the filter sock 96 serves as the method by which the tracer wire 42 is affixed to the outer/exterior surface 46 of the drain tile 41. In such embodiments, the filter sock 96 may frictionally hold the tracer wire 42 in place against the outer/exterior surface 46 of the drain tile, or the filter sock 96 may be used in conjunction with adhesives or other methods that fix the tracer wire 42 to the outer/exterior surface 46 of the drain tile 41. In embodiments where the corrugated drain tile 41 is porous or perforated, the filter sock 96 also functions to reduce the debris which enters the drain tile 41.

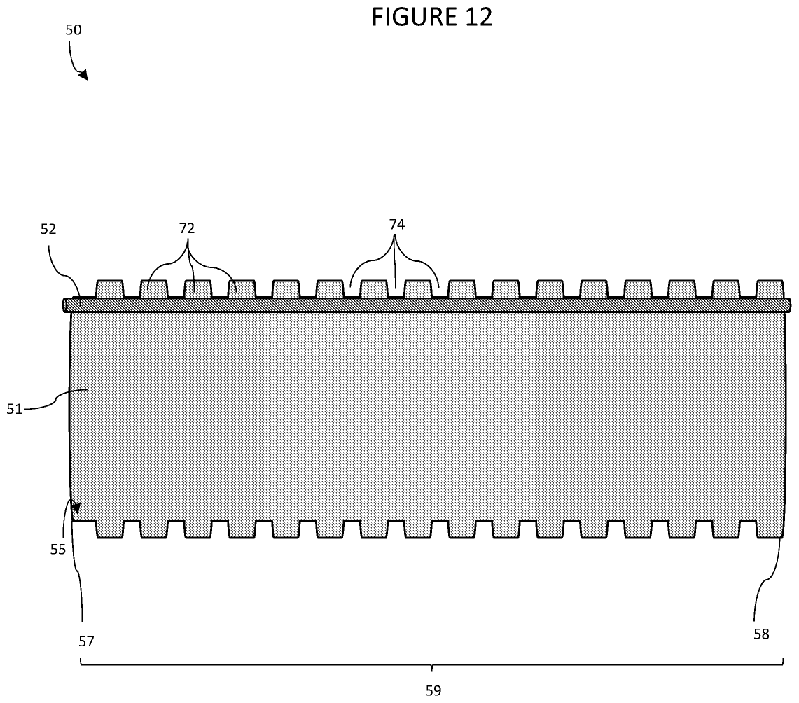

FIG. 12 is a longitudinal cross section view of another embodiment of drain system where a tracer wire 52 is adhered to an inner/interior surface 55 of a corrugated drain tile 51. In this embodiment, the tracer wire 52 is adhered only to the interior surface 55 at the plurality of grooves 74, such that the tracer wire 52 spans over the plurality of ridges 72. However, other configurations are anticipated by this disclosure. In one embodiment, the tracer wire 52 is bent and runs in juxtaposition with the ridges 72 and grooves 74 so as to be in continuous contact with the inner/interior surface 55 of the drain tile 51. In preferred embodiments, the tracer wire 52 is affixed to the inner/interior surface 55 the drain tile 51 such that the tracer wire 52 is detached and is at no point embedded, encapsulated, or otherwise housed within any portion of the drain tile 51. However, it is anticipated that in other embodiments, portions of the tracer wire 52 may be embedded, such as in an embodiment where the tracer wire 52 bisects the ridges 72 so as to be partially encapsulated within the ridges 72 while remaining affixed to the inner/interior surface 55 of the drain tile 51 when running through the ridges 72.

In some embodiments, the drain tile 51 is encased within the filter sock 96. The filter sock may encase corrugated tile that is solid/non-perforated or perforated. In perforated tile, the filter sock helps to reduce the debris which enters the drain tile 51.

The corrugated drain tile 41, 50 is preferably made of a strong, durable, and rust resistant material. In preferred embodiments, the corrugated drain tile 41, 51, is made of a durable and malleable plastic, such as polyvinyl chloride (PVC) or high-density polyethylene (HDPE).

To splice tracer wire 12, 22, 32, 42, 52 from two different portions of drainage system 10, 20, 30, 40, 50 together, a portion of the first end 17, 27, 37, 47, 57 and/or second end 18, 28, 38, 48, 58 of drain tile 11, 21, 31, 41, 51 is cut and removed from the drain tile body 12, 23, 33, without cutting or damaging the attached tracer wire 12, 22, 32, 42, 52. The tracer wire 12, 22, 32, 42, 52 will thus extend beyond the first end 17, 27, 37, 47, 57 and/or second end 18, 28, 38, 48, 58 of the drain tile 11, 21, 31, 41, 51 and can be spliced with tracer wire from a different section of drainage system 10, 20, 30, 40, 50. Splicing may be accomplished by twisting the tracer wire 12, 22, 32, 42, 52 from two different sections of drain tile 11, 21, 31, 41, 51 together, by utilizing a butt splice, or by utilizing a wire nut.

The present disclosure envisions the use of drain tile 11, 21, 31 of various sizes, including drain tile 11, 21, 31, 41, 51 that is one and a half inches in diameter, three inches in diameter, four inches in diameter, six inches in diameter, or larger. In some embodiments the drain tile 11, 21, 31, 41, 51 may be as large as six feet in diameter or larger. However, all sizes of drain tile are also anticipated by this disclosure. Furthermore, all lengths of drain tile 11, 21, 31, 41, 51 are envisioned by this disclosure. In some embodiments the longitudinal length 19, 28, 39, 49, 59 of the drain tile 11, 21, 31, 41, 51 is ten feet. In other embodiments the longitudinal length 19, 29, 39, 49, 59 is fifty feet. In other embodiments, the longitudinal length 19, 29, 39, 49, 59 is one hundred feet or longer.

The tracer wire 12, 22, 32, 42, 52 preferably defines any type of conductive wire. In some embodiments the tracer wire defines a conductive wire approximately 1/16 to ⅛ inch in diameter. Alternatively, the tracer wire 12, 22, 32, 42, 52 may be measured by gauge and may define approximately a 20 to 12-gauge wire. In some embodiments, the tracer wire 12, 22, 32, 42, 52 defines a copper wire. In another embedment the tracer wire 12, 22, 32, 42, 52 defines a steel wire. In some embodiments, the tracer wire 12, 22, 32, 42, 52 defines a copper coated steel wire. In yet other embodiments, the tracer wire 12, 22, 32, 42, 52 defines galvanized steel and is coated in a protective layer of zinc. Furthermore, in some embodiments, the tracer wire 12, 22, 32, 42, 52 defines a solid, malleable wire, while in other embodiments the tracer wire 12, 22, 32, 42, 52 defines a braided wire. In a preferred embodiment, the tracer wire 12, 22, 32, 42, 52 defines a stainless-steel wire that is both conductive and resistant to corrosion and rust.

Whether the tracer wire 12, 22, 32, 42, 52 runs along the inner/interior surface 15, 35, 45, 55 the outer/exterior surface 16, 26, 36, 46 or is embedded within the drain tile body 13, 23, 33, this disclosure envisions that the tracer wire 12, 22, 32, 42, 52 is affixed to the drain tile 11, 21, 31, 41, 51 during or post manufacture of the drain tile 11, 21, 31, 41, 51. This minimizes the risk that the drain tile 11, 21, 31, 41, 51 and tracer wire 12, 32, 32, 42, 52 become separated during transport or installation, minimizes the risk of damage to the tracer wire 12, 22, 32, 42, 52 and increases reliability in detecting the location of the drain tile 11, 21, 31, 41, 51 by way of the tracer wire 12, 22, 32, 42, 52. Moreover, affixing the tracer wire 12, 22, 32, 42, 52 to the drain tile 11, 21, 31, 41, 51 removes the need to buy and install tracer wire 12, 22, 32, 42, 52 separately from the drain tile 11, 21, 31, 41, 51. In some embodiments the tracer wire 12, 22, 32, 42, 52 is heat fixed to the drain tile body 13, 23, 33. In other embodiments the tracer wire 12, 22, 32, 42, 52 is affixed using adhesives and/or fasteners known to persons of ordinary skill in the art. However, other methods of fixing the tracer wire 12, 22, 32, 52, 52 to the drain tile 11, 21, 31, 41, 51 are contemplated by this disclosure.

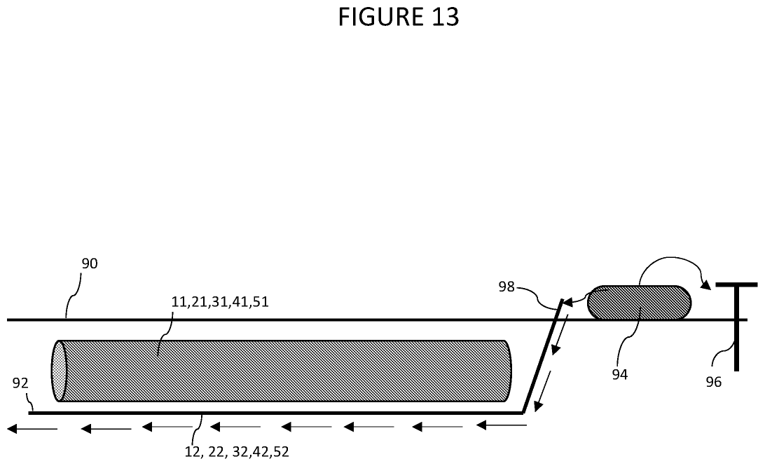

FIG. 13 illustrates a system for locating buried drainage system 10, 20, 30, 40, 50, the system comprising a drain tile 11, 21, 31, 41, 51 a tracer wire 12, 22, 32, 42, 52 affixed to the drain tile 11, 21, 31, 41, 51 and a transceiver 94 with a ground probe 96. The tracer wire 12, 22, 23 further comprises a first terminal end 98 and a second terminal end 92. The drain tile 11, 21, 31, 42, 52 additionally comprises a drain tile body 12, 23, 33, a first end 17, 27, 37, 47, 57 a second end 18, 28, 38, 48, 58 an outer/exterior surface 16, 26, 36, 46 and an inner/interior surface, 25, 35, 55. In some embodiments, the tracer wire 12, 42 is affixed to an outer/exterior surface 16, 46 of the drain tile 11, 41. In other embodiments, the tracer wire 22, 52 is affixed to an inner/interior surface 25, 55 of the drain tile 21, 51. In yet other embodiments, the tracer wire 32 is embedded within a drain tile body 33. In preferred embodiments, the first terminal end 48 and second terminal end 52 of the tracer wire 12, 22, 32, 42, 52 preferably extend beyond a first end 17, 27, 37, 47, 57 and/or second end 18, 28, 38, 48, 58 of the drain tile body 13, 23, 33 when the drainage system 10, 20, 30, 40, 50 is buried.

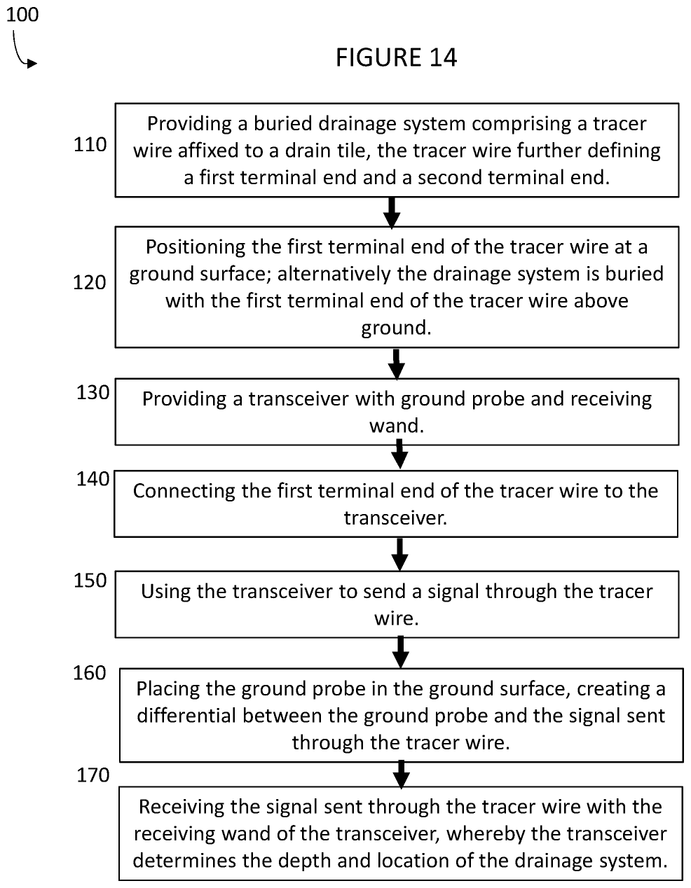

FIG. 14 is a flowchart further illustrating a method 100 for detecting the buried drainage system 10, 20, 30, 40, 50 as provided by this disclosure. At 110, the buried drainage system 10, 20, 30, 40, 50 is provided comprising the tracer wire 12, 22, 32, 42, 52 affixed to the drain tile 11, 21, 31, 41, 51. At 120, the first terminal end 98 of the tracer wire 12, 22, 32, 42, 52 is positioned at a ground surface 90. Alternatively, the drainage system 10, 20, 30, 40, 50 may be buried with the first terminal end 98 of the tracer wire 12, 22, 32, 42, 52 above ground. At 130, the transceiver 94 with a ground probe 96, and a receiving wand is provided. The transceiver 94 preferably transmits and receives signals, such as radio or electromagnetic signals, and may define a radio or electromagnetic receiver and transmitter. At 140 the first terminal end 98 of the tracer wire 12, 22, 32, 42, 52 is connected to the transceiver 94. The transceiver 94 may connect directly to the tracer wire 12, 22, 32, 42, 52, or it may clamp around the tracer wire 12, 22, 32, 42, 52 without directly touching it. At 150, the transceiver 94 sends a signal through the tracer wire 12, 22, 32, 42, 52. In some embodiments, the signal may be an electrical current. In other embodiments, the signal may be a radio signal. At 160 the ground probe 96 is placed in the ground surface 90, creating a differential between the ground probe 96 and the tracer wire 12, 22, 32, 42, 52. At 170, the receiving wand of the transceiver 94 wirelessly picks up the signal sent through the tracer wire 12, 22, 32, 42, 52 and determines the location and depth of the tracer wire 12, 22, 32, 42, 52. Because the tracer wire 12, 22, 32, 42, 52 is affixed to the drain tile 11, 21, 31, 41, 51 the location of the tracer wire 12, 22, 32, 42, 52 corresponds to the location of the drain tile 11, 21, 31, 41, 51.

Other embodiments additionally comprise a root and/or okra deterrent, such as copper, copper dust, copper sulfate, copper sulfate dust, zinc, or zinc dust. The root deterrent may be embedded within the drain tile 11, 21, 31, 41, 51 may coat the outer surface 16, 26, 36, 46 or inner surface 15, 25, 35, 55, or may otherwise be applied to prevent blockage of the drain tile 11, 21, 31, 41, 51 by roots or other plant material.

While the invention is described through the above-described exemplary embodiments, modifications to, and variations of, the illustrated embodiments may be made without departing from the inventive concepts disclosed herein. For example, although specific parameter values, such as dimensions, materials, additives and coatings, may be recited in relation to disclosed embodiments, within the scope of the invention, the values of all parameters may vary over wide ranges to suit different applications.

As used herein, including in the claims, the term “and/or,” used in connection with a list of items, means one or more of the items in the list, i.e., at least one of the items in the list, but not necessarily all the items in the list. As used herein, including in the claims, the term “or,” used in connection with a list of items, means one or more of the items in the list, i.e., at least one of the items in the list, but not necessarily all the items in the list. “Or” does not mean “exclusive or.”

Disclosed aspects, or portions thereof, may be combined in ways not listed above and/or not explicitly claimed. In addition, embodiments disclosed herein may be suitably practiced, absent any element that is not specifically disclosed herein. Accordingly, the invention should not be viewed as being limited to the disclosed embodiments.

What is claimed is:

1. A drainage system for use in a post burial detection thereof, the drainage system comprising:
a corrugated drain tile, the drain tile comprising:
a drain tile body, wherein the drain tile body defines a body wall, a body wall thickness, a first end, a second end, and a longitudinal length extending between the first and second ends; and
a tracer wire having a length;
wherein the tracer wire is affixed along the length of the tracer wire to the drain tile body along the longitudinal length of the drain tile, but is at no point embedded within the body of the drain tile; and
wherein the tracer wire is configured to indicate a buried location of the drain tile body.

2. The drainage system of claim 1, wherein the drain tile body is tube shaped and the drain tile body further defines an inner/interior surface, an outer/exterior surface, an inner diameter and an outer diameter.

3. The drainage system of claim 2, wherein the inner diameter further defines a void that extends along the longitudinal length.

4. The drainage system of claim 3, wherein the corrugated drain tile is non-perforated.

5. The drainage system of claim 3, wherein the corrugated drain tile is perforated.

6. The drainage system of claim 3, wherein the corrugated drain tile is encased in a filter sock.

7. The drainage system of claim 6, wherein the tracer wire is affixed to the drain tile by way of the filter sock.

8. The drainage system of claim 3, wherein the drain tile is formed of polyvinyl chloride.

9. The drainage system of claim 3, wherein the drain tile is formed of high-density polyethylene.

10. The drainage system of claim 1, wherein the tracer wire is formed of a conductive material.

11. The drainage system of claim 10, wherein the tracer wire is formed of steel wire.

12. The drainage system of claim 10, wherein the tracer wire is formed of copper wire.

13. The drainage system of claim 10, wherein the tracer wire is formed of stainless-steel wire.

14. The drainage system of claim 10, wherein the tracer wire is formed of copper clad steel.

15. The drainage system of claim 3, wherein the tracer wire is affixed to the drain tile along the inner/interior surface of the drain tile.

16. The drainage system of claim 3, wherein the tracer wire is affixed to the drain tile along the outer/exterior surface of the drain tile.

17. The drainage system of claim 16, wherein the tracer wire is affixed to the drain tile by way of a filter sock.

18. The drainage system of claim 3, wherein the tracer wire is affixed to the drain tile between the outer/exterior surface of the drain tile and a filter sock.
